(19) United States
(12) Patent Application Publication
(10) Pub. No.: US 2019/0210255 A1
(43) Pub. Date: Jul. 11, 2019

(54) DEVICE AND PROCESS FOR PRODUCING COMPOSITE STRUCTURES

(71) Applicant: SABIC GLOBAL TECHNOLOGIES B.V., Bergen op Zoom (NL)

(72) Inventors: Somasekhar Bobba Venkat, East Greenbush, NY (US); Raghavendra Janiwarad, Bangalore (IN); Kylie Speirs, Pittsfield, MA (US); Craig Lawrence Milne, Pittsfield, MA (US); RN Ashwin Kumar, Bangalore (IN)

(21) Appl. No.: 16/326,573

(22) PCT Filed: Aug. 24, 2017
(86) PCT No.: PCT/US2017/048312

§ 371 Date: Feb. 19, 2019

(30) Foreign Application Priority Data
Aug. 24, 2016 (IN) 201611028773

(51) Int. Cl. B29C 43/38; B29C 70/34; B29C 33/38; B29C 70/46; B30B 15/06

(52) U.S. Cl. CPC B29C 43/38; B29C 70/34; B29C 33/38; B29C 70/465; B29K 2105/089; B30B 15/064; B29K 2909/02; B29K 2995/0015; B30B 15/061

(57) ABSTRACT

A device for producing a composite part includes a first platen structure, a second platen structure, a first plate structure, a second plate structure, a first press pad, and a second press pad. The first platen structure, the first plate structure, and the first press pad form a first assembly. The second platen structure, the second plate structure, and the second press pad form a second assembly. A cavity for receiving a laminate is arranged between the first assembly and the second assembly, the cavity including a wall structure arranged to surround the laminate. The wall structure includes an insulating material. A process for the device is also described.

### FIELD OF THE DISCLOSURE

The present disclosure is directed to devices and methods for producing composite structures, and in particular to devices and methods of making consolidated thermoplastic resin-based composite laminates with controlled processes to minimize resin flash for high viscous thermoplastic resins

### BACKGROUND OF THE DISCLOSURE

Various approaches to producing composite parts utilize processes like resin transfer molding, vacuum bagging and hot press methods. For thermoplastic-based laminates, hot press processes have been found to be suitable for woven fabric composite laminates where a resin is in the form of a melt impregnated, powder coated and/or co-mingled fiber form. However, previous approaches to using hot press processes have resulted in substantial and undesirable flash.

These and other shortcomings are addressed by aspects of the present disclosure.

### SUMMARY OF THE DISCLOSURE

In one aspect, a process configured to produce a composite part includes a first platen structure, a second platen structure, a first plate structure, a second plate structure, a first press pad and a second press pad. The first platen structure, the first plate structure, and the first press pad form a first assembly. The second platen structure, the second plate structure, and the second press pad form a second assembly. A cavity for receiving a laminate is arranged between the first assembly and the second assembly, the cavity including a wall structure arranged to surround (or substantially surround) the laminate. The wall structure includes an insulating material.

In another aspect, a device configured to produce a composite part includes providing a first platen structure, providing a second platen structure, providing a first plate structure, providing a second plate structure, providing a first press pad and providing a second press pad. The first platen structure, the first plate structure, and the first press pad are arranged to form a first assembly. The second platen structure, the second plate structure, and the second press pad are arranged to form a second assembly. A laminate is received in a cavity between the first assembly and the second assembly, the cavity including a wall structure arranged to surround the laminate. The wall structure includes an insulating material.

Additional features, advantages, and aspects of the disclosure may be set forth or apparent from consideration of the following detailed description, drawings, and claims. Moreover, it is to be understood that both the foregoing summary of the disclosure and the following detailed description are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate aspects of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1 shows an aspect of a device for producing composite parts according to the principles of the disclosure.

FIG. 2 shows another aspect of a device for producing composite parts according to FIG. 1.

FIG. 3 shows the temperature and pressure profile applicable to a device for producing composite parts according to the principles of the disclosure.

FIG. 4 shows the process according to FIG. 3.

FIG. 5 shows a further aspect of a device for producing composite parts according to the principles of the disclosure.

FIG. 6 shows a heating process applicable to the device for producing composite parts of FIG. 5 according to the principles of the disclosure.

FIG. 7 shows a further aspect of a device for producing composite parts according to the principles of the disclosure.

FIG. 8 shows a controller constructed according to the principles of the disclosure.

### DETAILED DESCRIPTION OF THE DISCLOSURE

The aspects of the disclosure and the various features and advantageous details thereof are explained more fully with reference to the non-limiting aspects and examples that are described and/or illustrated in the accompanying drawings and detailed in the following description. It should be noted that the features illustrated in the drawings are not necessarily drawn to scale, and features of one aspect may be employed with other aspects as the skilled artisan would recognize, even if not explicitly stated herein. Descriptions of well-known components and processing techniques may be omitted so as to not unnecessarily obscure the aspects of the disclosure. The examples used herein are intended merely to facilitate an understanding of ways in which the disclosure may be practiced and to further enable those of skill in the art to practice the aspects of the disclosure. Accordingly, the examples and aspects herein should not be construed as limiting the scope of the disclosure, which is defined solely by the appended claims and applicable law. Moreover, it is noted that like reference numerals represent similar parts throughout the several views of the drawings.

The disclosure is directed to devices and methods of making consolidated thermoplastic resin-based composite laminates with controlled processes to minimize resin flash for high viscous thermoplastic resins. With controlled lamination processes, flash control is achieved with an overall part and/or healthy laminate area increase from 50% to 95%. A healthy laminate area may be defined as a usable structure having good stiffness and strength.

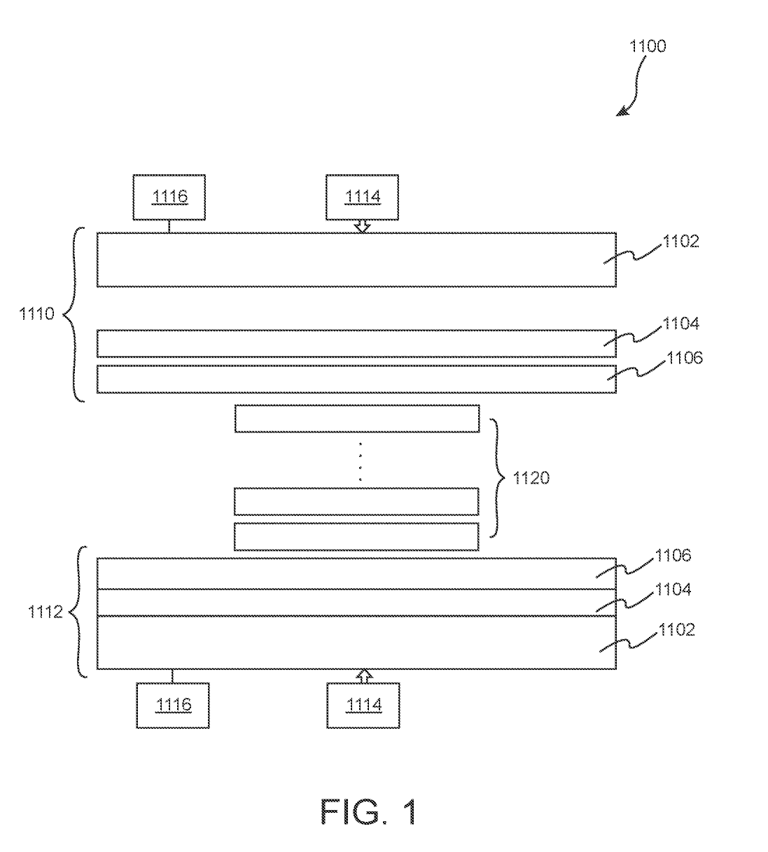

FIG. 1 shows an aspect of a device for producing composite parts according to the principles of the disclosure. In particular, FIG. 1 shows a static press 1100 that may include a hot platen 1102 as part of an upper structure 1110. The static press 1100 further may include another hot platen 1102 as part of a lower structure 1112. The hot platen 1102 may be heated by a heater 1116 implementing any known heating technology including a source of heated fluid such as hot air, hot water, steam, hot oil, and the like, moreover, the hot platen 1102 may be heated by a heater 1116 implementing any known heating technology including inductive heat, resistive heat, a coil rod heater, and the like. In one aspect, the heater 1116 may be implemented as a spiral shaped heating element. The spiral shaped heating element implementation of the heater 1116 may be configured to operate such that the center of the spiral is initially heated and the heat slowly spreads along the spiral construction to eventually heat the outer circumferential portions of the spiral heating element thus providing a sequential heating from the center outwardly. In another aspect, the heater 1116 may be actuated in a pulsating manner to provide greater control of the heater 1116. In a further aspect, the heater 1116 may be controlled by a pulse width modulation device. The static press 1100 may further be implemented with an actuation mechanism 1114 to move one or more of the hot platens 1102 towards and away from one another. The actuation mechanism 1114 may be implemented as a hydraulic actuator, a pneumatic actuator, an electromagnetic actuator, or the like. If a hydraulic actuator is utilized, the hydraulic actuator may include a hydraulic cylinder and a source of pressurized hydraulic fluid configured as a hydraulic system. If a pneumatic actuator is utilized, the pneumatic actuator may include a pneumatic cylinder and a source of pressurized pneumatic fluid configured as a pneumatic system. If an electromagnetic actuator is utilized, the electromagnetic actuator may include a solenoid and a source of electrical power to operate the solenoid configured as an electromagnetic system. Other implementations are contemplated as well.

The static press 1100 further may include a press pad 1104 arranged below the hot platen 1102 of the upper structure 1110 and another press pad 1104 arranged above the hot platen 1102 of the lower structure 1112. The static press 1100 further may include a plate 1106 arranged below the press pad 1104 of the upper structure 1110 and another plate 1106 arranged above the press pad 1104 of the lower structure 1112. In one aspect, the plates 1106 may be formed of a metallic material. In one aspect, the plates 1106 may be formed of steel. In one aspect, the plates 1106 may be formed of stainless steel.

In particular, the static press process according to the disclosure may utilize a press pad 1104 between the hot platen 1102 and a tooling construction that balances a surface area pressure uniformity across a sample. In one aspect, the press pad 1104 construction can be any high heat material acting as an insulator or a heat transfer mechanism. In one aspect, the press pad 1104 construction utilizing a high heat material acting as an insulator may include woven materials acting as insulators including one or more of an aramid fiber such as, for example, para-aramid fiber (e.g., Kevlar™) or meta-aramid fiber (Nomex™), or a glass, and the like. In one aspect, the press pad 1104 construction utilizing a high heat material acting as an insulator may include a nonwoven material such as silicone. Other materials are contemplated as well.

In one aspect, the press pad 1104 construction utilizing a heat transfer material found to be beneficial for pressure balance is graphite sheeting. The graphite sheeting has been found to work exceptionally well for both heat transfer and equalizing surface area pressure because of its unique compressibility and relaxation properties allowing multiple uses. Other materials are contemplated as well.

The static press 1100 may further include an area to receive a laminate 1120 arranged below the plate 1106 of the upper structure 1110 and above the plate 1106 of the lower structure 1112. In one aspect, the laminate 1120 may be a plurality of laminate layers. In one aspect, the laminate 1120 may be placed in the static press 1100 and removed from the static press 1100 with a robot (not shown).

In one aspect, the laminate 1120 may be made from a first fiber-reinforced polymer material as defined herein. In one aspect, the laminate 1120 may also include a first thermoplastic resin as defined herein. In one aspect, the first fiber-reinforced polymer material and the first thermoplastic resin share a common polymeric material. In one aspect, the laminate 1120 may be made from a first fiber-reinforced polymer material comprising amorphous polymers, semi crystalline polymers, crystalline polymers and combinations thereof. In another aspect, the laminate 1120 may be made from a first fiber-reinforced polymer material comprising carbon fiber. In another aspect, the laminate 1120 may be made from a first fiber-reinforced polymer material comprising amorphous polymers, semi crystalline polymers, crystalline polymers and combinations thereof and carbon fiber. In one aspect, the laminate 1120 may be made from a first fiber-reinforced polymer and a second fiber-reinforced polymer material as defined herein. In one aspect, the laminate 1120 may also include a first thermoplastic resin and a second thermoplastic resin as defined herein.

Although FIG. 1 shows the hot platen 1102, the press pad 1104, and the plate 1106 having a generally flat shape, the shape is merely exemplary. Any one or more of the hot platen 1102, the press pad 1104, and the plate 1106 can have a non-flat shape. In this regard, the hot platen 1102, the press pad 1104, and the plate 1106 may have a shape consistent with the final part to be produced. Thus, the hot platen 1102, the press pad 1104, and the plate 1106 can be arranged with any two-dimensional or three-dimensional shape.

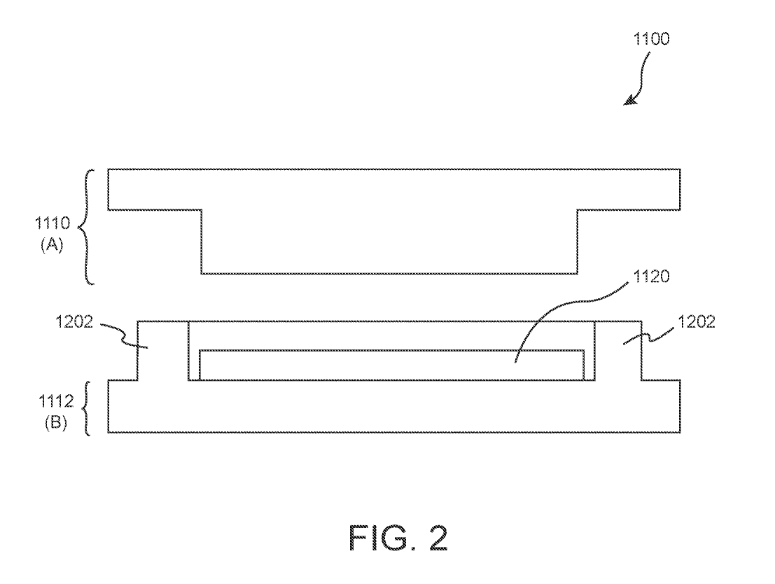

FIG. 2 shows another aspect of a device for producing composite parts according to FIG. 1. In particular, FIG. 2 shows the static press 1100 that includes the upper structure 1110 and the lower structure 1112 as described above. The static press 1100 may further include an insulator 1202 as part of the walls. In one aspect, the insulating material may be a ceramic material insulator or may include ceramic.

In this regard, the static press 1100 construction according to the disclosure results in improved resin flash control with the ceramic insulator 1202 arranged around a perimeter of the laminate 1120. In one aspect, a tooling of the static press 1100 may be a sheer edge concept design where mold half A (upper structure 1110) telescopes into mold half B (lower structure 1112). Telescope may refer to the structural characteristic of forcing together, one into another, or forcing into another component, in the manner of the sliding tubes of a jointed telescope. In one aspect, the mold half B may be constructed as a cavity with the cavity walls made of the insulator 1202. In this aspect, the remaining portion of the tool may be constructed of a conductive heat transfer material. In this regard, the mold half A may be a male half construction of a conductive heat transfer material that fits into the mold half B. The insulator 1202, such as a ceramic insulator, within the mold half B may act as a heat sink restricting the polymer resin flow from the known “path of least resistance” directing the polymer to remain in the construction makeup of the laminate 1120. The insulator 1202 may create a significant heat delta, i.e., a change in heat or temperature, and allow for pressure through a ceramics known compressibility. These and other disclosed features have been shown to reduce flash.

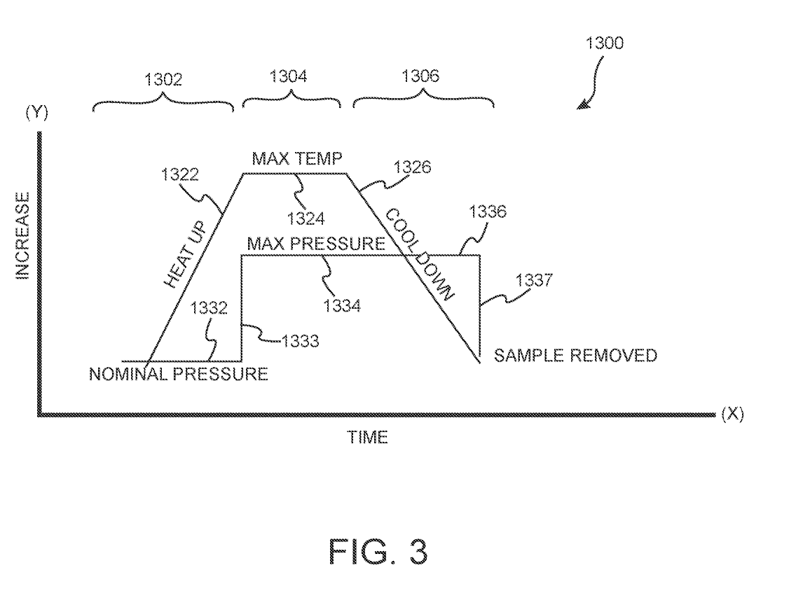

FIG. 3 shows a temperature and pressure profile applicable to a device for producing composite parts according to the principles of the disclosure. The disclosure further contemplates controlled process parameters for improving resin melt viscosity and controlling melt flow saturating into woven fabric, unidirectional fiber materials, like materials, and combinations thereof, improving fiber wet out. This process may allow the resin soak time using co-mingled, co-woven, co-wrapped, woven with films, woven with pre-pregs and the like to wick or saturate the fiber material of the laminate 1120 over time with a controlled pressure increase. By slowly increasing pressure to the laminate 1120, the shear reduction controls resin flow from the material being consolidated. It should be noted, that the disclosed device and process does not change the properties of the materials, the disclosed device and process controls the properties of materials in a desired manner.

As shown in FIG. 3, a temperature and pressure of the process is shown along the y-axis and time is shown along the x-axis. During a first phase 1302, the static press 1100 may be operated at a nominal pressure along line 1332 in conjunction with the actuation mechanism 1114. On the other hand, during the first phase 1302, the static press 1100 may be operated to increase heat along the line 1322 in conjunction with operation of the heater 1116. In one aspect, the process may be conducted in a vacuum to alleviate resin degradation in the laminate 1120.

During a second phase 1304, the static press 1100 may be operated at the higher pressure along line 1334 in conjunction with the actuation mechanism 1114. In one aspect, the higher pressure along line 1334 is a maximum pressure. In one aspect, the pressure along line 1334 is gradually applied. In one aspect, the pressure along line 1334 is gradually applied along line 1333 in incremental steps. On the other hand, during the second phase 1304, the static press 1100 may be operated a high heat along the line 1324 in conjunction with operation of the heater 1116. In one aspect, the high heat along line 1324 may be maximum heat, in that a maximum temperature has been reached.

During a third phase 1306, the static press 1100 may be operated at a higher pressure along line 1336 in conjunction with the actuation mechanism 1114. In one aspect, the higher pressure along line 1334 is a maximum pressure. On the other hand, during the third phase 1306, the static press 1100 may be operated to cool down along the line 1326 in conjunction with discontinued operation of the heater 1116. In one aspect, the cool down process may include providing a source of coolant.

After the third phase 1306, the static press 1100 may be operated to reduce pressure along line 1337 in conjunction with discontinued and/or reduced operation of the actuation mechanism 1114. Thereafter, the laminate 1120 may be removed and may be further processed.

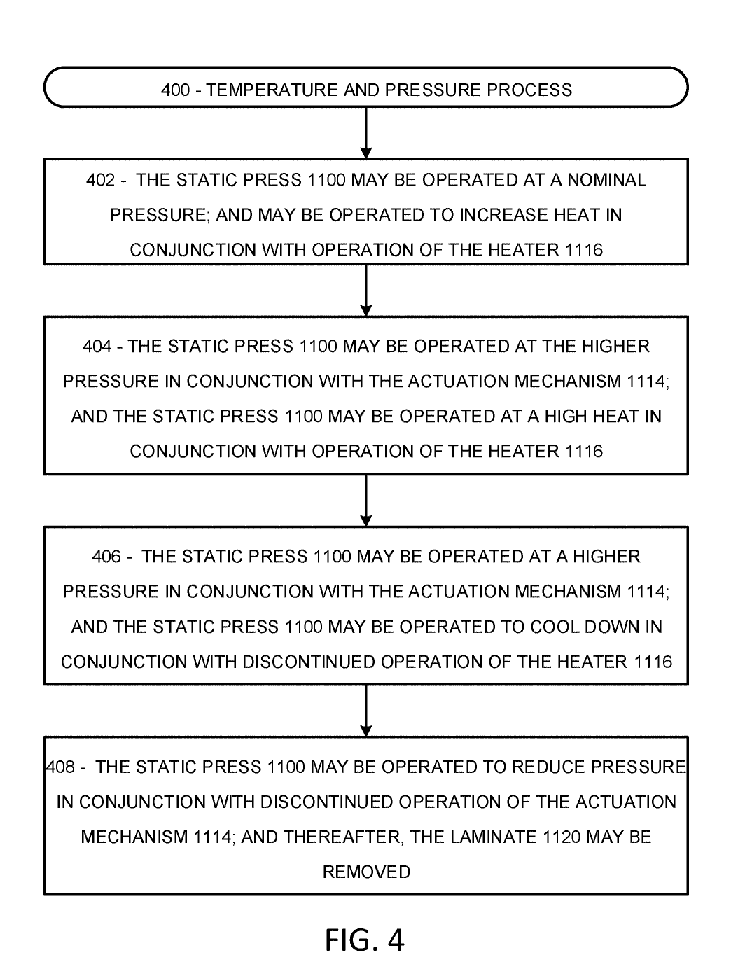

FIG. 4 shows the process according to FIG. 3. In particular, FIG. 4 shows a temperature and pressure process 400. As shown in box 402, the static press 1100 may be operated on the laminate 1120 at a nominal pressure in conjunction with the actuation mechanism 1114. On the other hand, the static press 1100 may be operated to increase heat in conjunction with operation of the heater 1116.

As shown in box 404, the static press 1100 may be operated at the higher pressure in conjunction with the actuation mechanism 1114. In one aspect, the higher pressure is a maximum pressure. In one aspect, the pressure is gradually applied to the laminate 1120. On the other hand, the static press 1100 may be operated at a high heat in conjunction with operation of the heater 1116. In one aspect, the high heat may be maximum heat.

As shown in box 406, the static press 1100 may be operated at a higher pressure in conjunction with the actuation mechanism 1114. In one aspect, the higher pressure is a maximum pressure. On the other hand, the static press 1100 may be operated to cool down in conjunction with discontinued and/or reduced operation of the heater 1116. In one aspect, the cool down may include providing a source of coolant.

As shown in box 408, the static press 1100 may be operated to reduce pressure in conjunction with discontinued operation of the actuation mechanism 1114. Thereafter, the laminate 1120 may be removed and may be further processed.

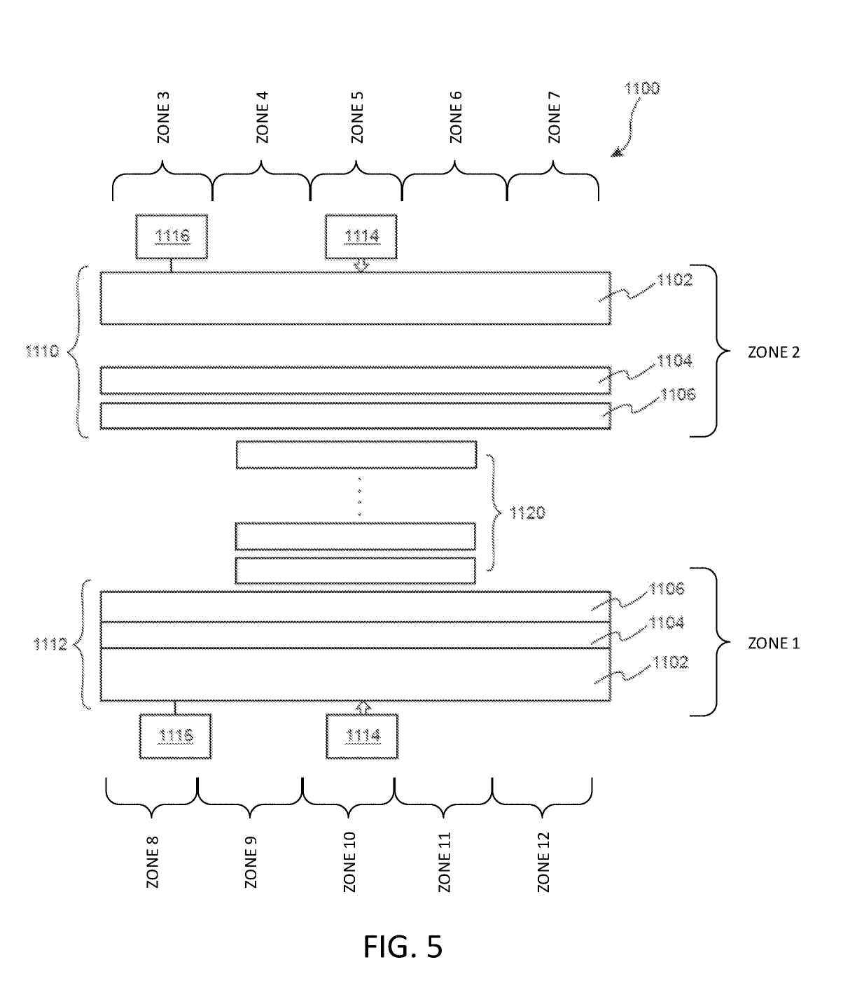

FIG. 5 shows a further aspect of a device for producing composite parts according to the principles of the disclosure. In particular, FIG. 5 illustrates that the hot platen 1102 may be heated by a heater 1116 that is implemented with a plurality of heaters 1116 each heating a zone of the hot platen 1102. In this regard, there may be any number of heaters 1116 and any number of zones. As shown in the exemplary FIG. 5 aspect, the heaters 1116 may be implemented to heat any one or more of zone 3, zone 4, zone 5, zone 6, and zone 7 of the upper structure 1110 of the hot platen 1102. Similarly, the heaters 1116 may be implemented to heat any one or more zone 8, zone 9, zone 10, zone 11, and zone 12 of the lower structure 1112 of the hot platen 1102. As further shown in FIG. 5, the heaters 1116 may be implemented to heat zone 1, which may include zone 3, zone 4, zone 5, zone 6, and zone 7 of the upper structure 1110 of the hot platen 1102. Similarly, the heaters 1116 may be implemented to heat zone 2, which may include zone 8, zone 9, zone 10, zone 11, and zone 12 of the lower structure 1112 of the hot platen 1102.

In one aspect, operation of the heaters 1116 may be controlled by the controller 350 to heat zone 1 during part of the first phase 1302, second phase 1304, and/or third phase 1306. Thereafter, the heaters 1116 may be controlled by the controller 350 to heat zone 2 during another part of the first phase 1302, second phase 1304, and/or third phase 1306. In other words, the heaters 1116 may be controlled to heat zone 1 and zone 2 during different time periods. The time periods may overlap. In one aspect, zone 1 may be heated first followed by heating zone 2. In another aspect, zone 2 may be heated first followed by heating zone 1.

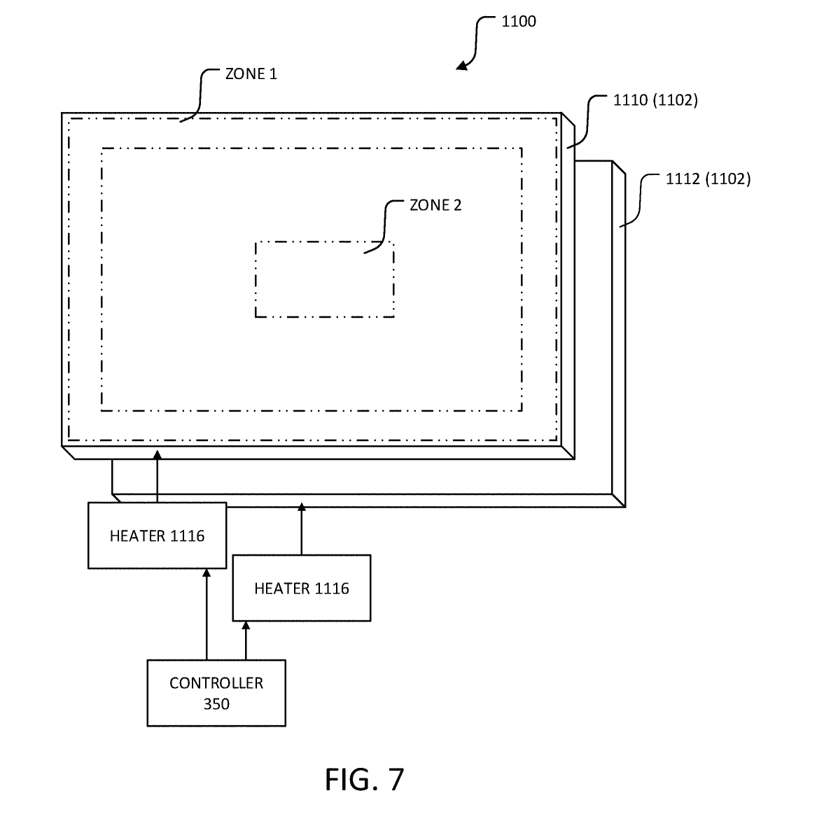

In one aspect, operation of the heaters 1116 may be controlled by the controller 350 (as in FIG. 7) to heat zone 5 during part of the first phase 1302, second phase 1304, and/or third phase 1306. Thereafter, the heaters 1116 may be controlled by the controller 350 to heat zone 4 and zone 6 during another part of the first phase 1302, second phase 1304, and/or third phase 1306. Thereafter, the heaters 1116 may be controlled by the controller 350 to heat zone 3 and zone 7 during another part of the first phase 1302, second phase 1304, and/or third phase 1306. In other words, the heaters 1116 may be controlled to heat any one or more of zones 3-7 during different time periods. The time periods may overlap. In one aspect, zone 5 may be heated first followed by heating zone 4 and zone 6, and then heating zone 3 and zone 7. In another aspect, zone 3 and zone 7 may be heated first followed by heating zone 4 and zone 6, and then heating zone 5. Each of zones 8-12 may be operated in a similar manner.

In one aspect, operation of the heaters 1116 may include distinct sequential heating in only one of the plurality of zones. In one aspect, operation of the heaters 1116 may include distinct sequential heating in more than one of the plurality of zones, but not all of the plurality of zones simultaneously. In one aspect, operation of the heaters 1116 may include sequential heating in more than one of the plurality of zones during time periods that overlap. In one aspect, operation of the heaters 1116 may result in temperature gradients between different locations of the laminate 1120. In one aspect, selective heating of the plurality of zones controls the flow of resin in the laminate 1120. In one aspect, selective heating of the plurality of zones controls the direction of flow of resin in the laminate 1120. In one aspect, selective heating of the plurality of zones starts in the center of the laminate 1120 and moves to the edges. In one aspect, selective heating of the plurality of zones starts in the edges of the laminate 1120 and moves to the center. In one aspect, selective heating of the plurality of zones starts in the top of the laminate 1120 and moves to the bottom. In one aspect, selective heating of the plurality of zones starts in the bottom of the laminate 1120 and moves to the top. Accordingly, with the zone-based heating of the static press 1100, the hot platen 1102 may be heated in any desired sequential manner to improve laminate production and reduce flash.

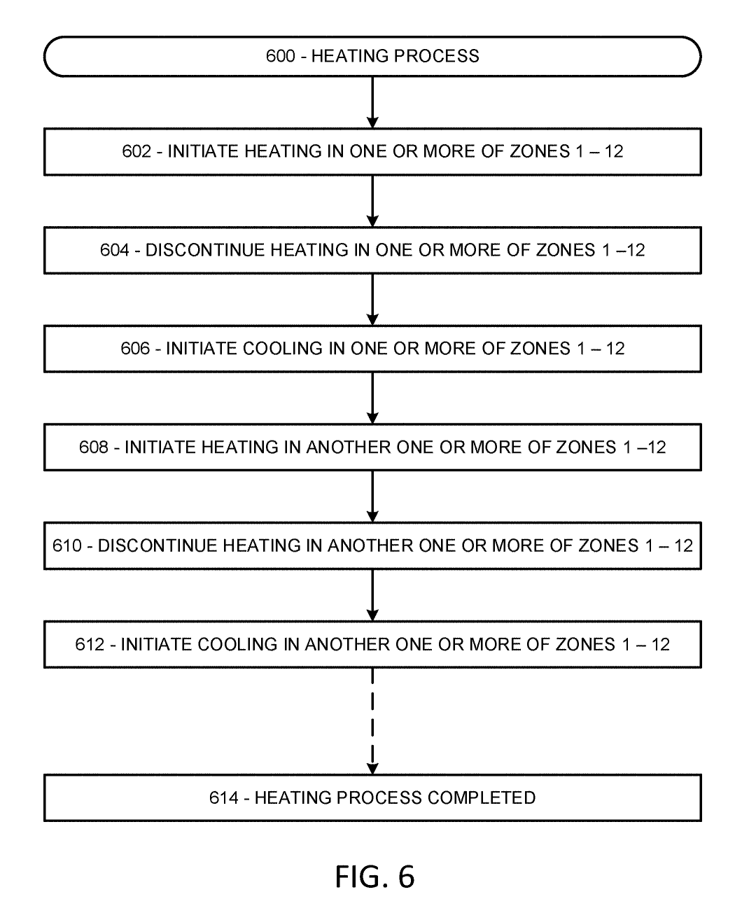

FIG. 6 shows a heating process applicable to the device for producing composite parts of FIG. 5 according to the principles of the disclosure. In particular, FIG. 6 illustrates a heating process 600 selectively heating one or more zones of the static press 1100. In one aspect, the heating process 600 may be utilized in conjunction with process 400. With respect to the heating process 600, any one of steps 602-612 may be implemented in any order. Moreover, any one of steps 602-612 may not be implemented by the process 600. In other words, the heating process 600 does not require each of steps 602-612.

As shown in box 602 the controller 350 may initiate heating in one or more of zones 1-12 by controlling operation of the heaters 1116. As shown in box 604 the controller 350 may discontinue heating in one or more of zones 1-12 by controlling operation of the heaters 1116. As shown in box 606 the controller 350 may initiate cooling in one or more of zones 1-12 by providing a source of cooling to the respective zone.

As shown in box 608 the controller 350 may initiate heating in another one or more of zones 1-12 by controlling operation of the heaters 1116. As shown in box 610 the controller 350 may discontinue heating in another one or more of zones 1-12 by controlling operation of the heaters 1116. As shown in box 612 the controller 350 may initiate cooling in another one or more of zones 1-12 by providing a source of cooling to the respective zone.

The process steps noted above may be repeated for one or more of zones 1-12 as indicated by the dashed line. In this regard, the heating of one or more of zones 1-12 may be in any desired sequential order. As shown in box 614, the heating process 600 may be completed.

FIG. 7 shows a further aspect of a device for producing composite parts according to the principles of the disclosure. In particular, FIG. 7 illustrates that the hot platen 1102 may be heated by a heater 1116 that is implemented with a plurality of heaters 1116 each heating a zone of the hot platen 1102. In this regard, there may be any number of heaters 1116 and any number of zones. As shown in the exemplary FIG. 7 aspect, the heaters 1116 may be implemented to heat any one or more of zone 1 and zone 2 of the upper structure 1110 of the hot platen 1102. Zone 2 may be located centrally in the hot platen 1102 and zone 1 may be generally located on the periphery of the hot platen 1102. Similarly, the heaters 1116 may be implemented to heat any one or more zone 1 and zone 2 (not shown) of the lower structure 1112 of the hot platen 1102. Zone 1 and zone 2 of the lower structure 1112 having a similar placement to zone 1 and zone 2 of the upper structure 1110. In the aspect of FIG. 7, there may be separate and/or individual heat control of the heaters 1116 to control and provide polymer viscosity movement through the fiber matrix. In one aspect, this may be implemented by differential control to provide sequential heating from the center out or outside to the center. In one aspect, this may be implemented by differential control to provide sequential heating from the top to the bottom or from the bottom to the top.

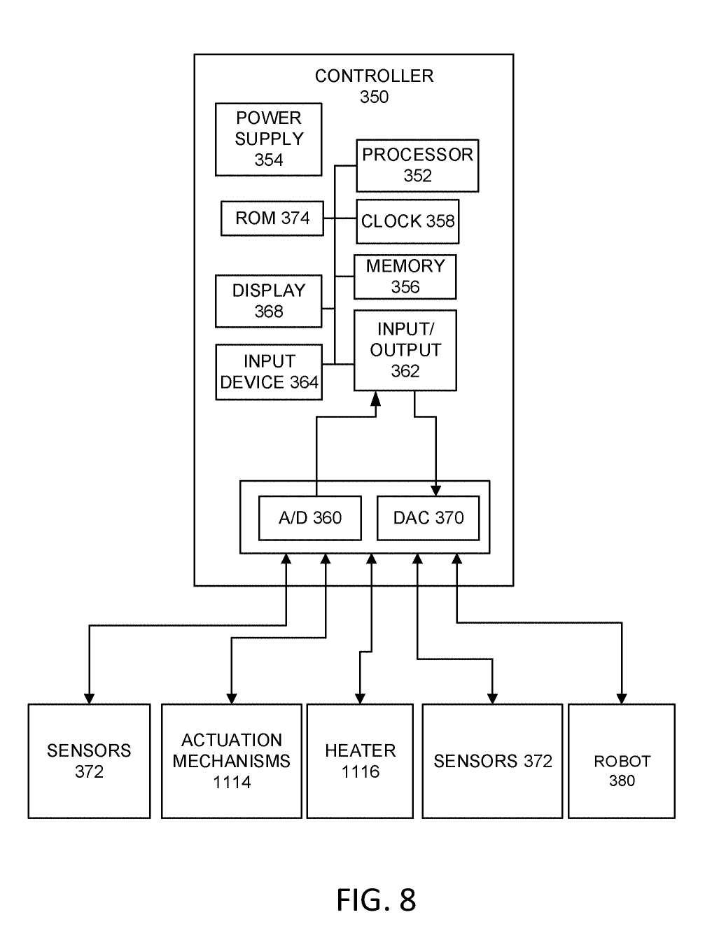

FIG. 8 shows a controller constructed according to the principles of the disclosure. The process of FIG. 3, the process of FIG. 4, and a process of FIG. 6, and the static press 1100 may be controlled by the controller 350 of FIG. 8, which may receive sensor outputs from one or more sensors 372, such as a temperature sensor sensing temperature from any part of the static press 1100 and associated system, a pressure sensor sensing pressure from a part of the static press 1100 and associated system, a position sensor sensing position of a part of the static press 1100 and associated system, and the like. The controller 350 and input/output (I/O) port 362 may be configured to control operation of the static press 1100 and receive signals from the static press 1100. These signals include signals from the sensors 372 and the like. The controller 350 may control operation the static press 1100 including the actuation mechanisms 1114, the heating and/or cooling device 1116, and the like.

The controller 350 may include a processor 352. This processor 352 may be operably connected to a power supply 354, a memory 356, a clock 358, an analog to digital converter (A/D) 360, an input/output (I/O) port 362, and the like. The I/O port 362 may be configured to receive signals from any suitably attached electronic device and forward these signals from the A/D 360 and/or to processor 352. These signals may include signals from the sensors 372. If the signals are in analog format, the signals may proceed via the A/D 360. In this regard, the A/D 360 may be configured to receive analog format signals and convert these signals into corresponding digital format signals.

The controller 350 may include a digital to analog converter (DAC) 370 that may be configured to receive digital format signals from the processor, convert these signals to analog format, and forward the analog signals from the I/O port 362. In this manner, electronic devices configured to utilize analog signals may receive communications or be driven by the processor 352. The processor 352 may be configured to receive and transmit signals to and from the DAC 370, A/D 360 and/or the I/O port 362. The processor 352 may be further configured to receive time signals from the clock 358. In addition, the processor 352 may be configured to store and retrieve electronic data to and from the memory 356. The controller 350 may further include a display 368, an input device 364, and a read-only memory (ROM) 374. Finally, the processor 352 may include a program stored in the memory 356 executed by the processor 352 to execute the process 400 and/or the process 600 described herein.

The controller 350 and I/O port 362 may be configured to control operation of the static press 1100 and receive signals from the static press 1100. These signals include signals from the sensors 372 and the like. The controller 350 may control operation the static press 1100 including the one or more actuation mechanisms 1114, the heater 1116, a robot 380, and the like.

Laminates 1120 utilizing the static press 1100 and the process associated described above were prepared. Ultrasonic C-Scans were carried out on the laminates 1120 made with both standard and controlled impregnation processes to study the wet-out and quality of laminates. Flexural tests were also carried out from samples cut from a cut-out area and these observed good stiffness and strength. The results showed healthy laminates, resin flash control was achieved, better impregnation and wet-out and flash waste was minimized by 50% resulting in cost savings. The disclosed controlled process parameters moreover improved resin melt viscosity and controlled melt flow saturating into woven fabric improving fiber wet out. The disclosed process provided resin soak time to wick or saturate the fiber material of the laminate over time with a controlled pressure increase. The disclosed process further controlled resin flow in the material being consolidated.

The first fiber-reinforced polymer material may include a laminate made from at least one of a uni-directional tape, a prepack roll, a two-dimensional fabric, a three-dimensional fabric, commingled fibers, a film, a woven fabric, and a non-woven fabric. The first fiber-reinforced polymer material may be made through a melt process, from a chemical solution, from a powder, by film impregnation, or the like. The woven and non-woven fabric materials may be made from the first thermoplastic resin. In one aspect, the first fiber-reinforced polymer material may include a first thermoplastic resin including one or more commingled fibers, a film, a powder, and/or the like.

Specific non-limiting examples of suitable first thermoplastic resins include polyacetal, polyacrylic, styrene acrylonitrile, acrylonitrile-butadiene-styrene (ABS), polycarbonate, polystyrene, polyethylene, polyphenylene ether, polypropylene, polyethylene terephthalate, polybutylene terephthalate, Nylons (Nylon-6, Nylon-6/6, Nylon-6/10, Nylon-6/12, Nylon-11 or Nylon-12, for example), polyamideimide, polyarylate, polyurethane, ethylene propylene diene rubber (EPR), ethylene propylene diene monomer (EPDM), polyarylsulfone, polyethersulfone, polyphenylene sulfide, polyvinyl chloride, polysulfone, polyetherimide, polytetrafluoroethylene, fluorinated ethylene propylene, perfluoroalkoxyethylene, polychlorotrifluoroethylene, polyvinylidene fluoride, polyvinyl fluoride, polyetherketone, polyether ether ketone (PEEK), liquid crystal polymers and mixtures comprising any one of the foregoing thermoplastics. The thermoplastic resin may also be propriety resin materials, such as Noryl GTX™, which is a blend of polyamide and modified polyphenylene ether, or Thermocomp™ RC008™, which is a Nylon 66 resin. It is anticipated that any thermoplastic resin may be used in the present disclosure that is capable of being sufficiently softened by heat to permit fusing and/or molding without being chemically or thermally decomposed.

The second fiber-reinforced polymer material may be selected from the non-exhaustive list of the first fiber-reinforced polymer material described herein. The second thermoplastic resin may be selected from the non-exhaustive list of first thermoplastic resins described above. Although the second thermoplastic resin may be different than the first thermoplastic resin, it may be desirable that the first thermoplastic resin and the second thermoplastic resin share a common polymeric material. The specific materials mentioned above are merely described for exemplary purposes.

The first fiber-reinforced polymer material may also include at least one type of continuous fiber material designed to help provide strength to the laminate 1120. Fibers suitable for use in the disclosure include glass fibers, carbon fibers, graphite fibers, synthetic organic fibers, particularly high modulus organic fibers such as para- and meta-aramid fibers, nylon fibers, polyester fibers, or any of the thermoplastic resins mentioned above that are suitable for use as fibers, natural fibers such as hemp, sisal, jute, flax, coir, kenaf and cellulosic fibers, mineral fibers such as basalt, mineral wool (e.g., rock or slag wool), Wollastonite, alumina silica, and the like, or mixtures thereof, metal fibers, metalized natural and/or synthetic fibers, ceramic fibers, or mixtures thereof. In one aspect, the fibers selected for the first fiber-reinforced polymer material of the laminate 1120 are continuous carbon fibers.

Articles produced according to the disclosure include, for example, computer and business machine housings, home appliances, trays, plates, handles, helmets, automotive parts such as instrument panels, cup holders, glove boxes, interior coverings and the like. In various further aspects, formed articles include, but are not limited to, food service items, medical devices, animal cages, electrical connectors, enclosures for electrical equipment, electric motor parts, power distribution equipment, communication equipment, computers and the like, including devices that have molded in snap fit connectors. In a further aspect, articles of the present disclosure include exterior body panels and parts for outdoor vehicles and devices including automobiles, protected graphics such as signs, outdoor enclosures such as telecommunication and electrical connection boxes, and construction applications such as roof sections, wall panels and glazing. Multilayer articles made of the disclosed polycarbonates particularly include articles which will be exposed to UV-light, whether natural or artificial, during their lifetimes, and most particularly outdoor articles; i.e., those intended for outdoor use. Suitable articles are exemplified by enclosures, housings, panels, and parts for outdoor vehicles and devices; enclosures for electrical and telecommunication devices; outdoor furniture; aircraft components; boats and marine equipment, including trim, enclosures, and housings; outboard motor housings; depth finder housings, personal water-craft; jet-skis; pools; spas; hot-tubs; steps; step coverings; building and construction applications such as glazing, roofs, windows, floors, decorative window furnishings or treatments; treated glass covers for pictures, paintings, posters, and like display items; wall panels, and doors; protected graphics; outdoor and indoor signs; enclosures, housings, panels, and parts for automatic teller machines (ATM); enclosures, housings, panels, and parts for lawn and garden tractors, lawn mowers, and tools, including lawn and garden tools; window and door trim; sports equipment and toys; enclosures, housings, panels, and parts for snowmobiles; recreational vehicle panels and components; playground equipment; articles made from plastic-wood combinations; golf course markers; utility pit covers; computer housings; desk-top computer housings; portable computer housings; lap-top computer housings; palm-held computer housings; monitor housings; printer housings; keyboards; facsimile machine housings; copier housings; telephone housings; mobile phone housings; radio sender housings; radio receiver housings; light fixtures; lighting appliances; network interface device housings; transformer housings; air conditioner housings; cladding or seating for public transportation; cladding or seating for trains, subways, or buses; meter housings; antenna housings; cladding for satellite dishes; coated helmets and personal protective equipment; coated synthetic or natural textiles; coated photographic film and photographic prints; coated painted articles; coated dyed articles; coated fluorescent articles; coated articles; and like applications.

In one aspect, the parts can include articles including the disclosed glass fiber filled polymeric materials. In a further aspect, the article including the disclosed glass fiber filled polymeric materials can be used in automotive applications. In a yet further aspect, the article includes the disclosed glass fiber filled polymeric materials can be selected from instrument panels, overhead consoles, interior trim, center consoles, panels, quarter panels, rocker panels, trim, fenders, doors, deck lids, trunk lids, hoods, bonnets, roofs, bumpers, fascia, grilles, minor housings, pillar appliqués, cladding, body side moldings, wheel covers, hubcaps, door handles, spoilers, window frames, headlamp bezels, headlamps, tail lamps, tail lamp housings, tail lamp bezels, license plate enclosures, roof racks, and running boards. In an even further aspect, the article including the disclosed glass fiber filled polymeric materials can be selected from mobile device exteriors, mobile device covers, enclosures for electrical and electronic assemblies, protective headgear, buffer edging for furniture and joinery panels, luggage and protective carrying cases, small kitchen appliances, and toys.

In one aspect, the parts can include electrical or electronic devices including the disclosed glass fiber filled polymeric materials. In a further aspect, the electrical or electronic device can be a cellphone, a MP3 player, a computer, a laptop, a camera, a video recorder, an electronic tablet, a pager, a hand receiver, a video game, a calculator, a wireless car entry device, an automotive part, a filter housing, a luggage cart, an office chair, a kitchen appliance, an electrical housing, an electrical connector, a lighting fixture, a light emitting diode, an electrical part, or a telecommunications part.

It is to be understood that the terminology used herein is for the purpose of describing particular aspects only and is not intended to be limiting. As used in the specification and in the claims, the term “comprising” can include the embodiments “consisting of” and “consisting essentially of” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

### EXAMPLES

### Example 1

A device configured to produce a composite part, comprising: a first platen structure; a second platen structure; a first plate structure; a second plate structure; a first press pad; a second press pad; the first platen structure, the first plate structure, and the first press pad forming a first assembly; the second platen structure, the second plate structure, and the second press pad forming a second assembly; and a cavity for receiving a laminate arranged between the first assembly and the second assembly, the cavity including a wall structure arranged to surround the laminate, wherein the wall comprises an insulating material.

### Example 2

The device according example 1 wherein the wall comprises a ceramic material.

### Example 3

The device according to any one of examples 1 to 2 further comprising an actuation mechanism configured to move the first assembly towards the second assembly to apply pressure to the laminate arranged in the cavity; and a heater, wherein the heater is configured during a first phase to heat the first platen structure and the second platen structure while the actuation mechanism applies a nominal pressure to the laminate arranged in the cavity; wherein the heater is further configured during a second phase to heat the first platen structure and the second platen structure while the actuation mechanism is configured to increase application of pressure to the laminate arranged in the cavity; and wherein the heater is configured to operate during a third phase to allow the first platen structure and the second platen structure to cool while the actuation mechanism is configured to continue to apply pressure to the laminate arranged in the cavity.

### Example 4

The device according to any one of examples 1 to 3 wherein the first assembly telescopes into the second assembly.

### Example 5

The device according to any one of examples 1 to 4 wherein the first assembly and the second assembly form a sheer edge press construction.

### Example 6

The device according to any one of examples 1 to 5 wherein the wall comprises an insulating material that is configured to provide a heat Delta.

### Example 7

The device according to any one of examples 1 to 6 wherein the wall comprises an insulating material that is configured to reduce flash.

### Example 8

The device according to any one of examples 1 to 7 wherein the first press pad and the second press pad comprise at least one of the following: para-aramid fiber, meta-aramid fiber, graphite sheeting, and glass.

### Example 9

The device according to any one of examples 1 to 8 wherein the laminate comprises a plurality of laminate layers.

### Example 10

The device according to any one of examples 1 to 9 further comprising a heater configured to heat the first platen structure and the second platen structure, the heat being transferred from the first platen structure and the second platen structure to the laminate.

### Example 11

The device according to any one of examples 1 to 10 wherein the first plate structure and the second plate structure comprises a metal.

### Example 12

The device according to any one of examples 1 to 11 wherein the first plate structure and the second plate structure comprises steel.

### Example 13

The device according to any one of examples 1 to 12 wherein the first plate structure and the second plate structure comprising stainless steel.

### Example 14

The device according to any one of examples 1 to 13 further comprising a plurality of heaters configured to heat the first platen structure and the second platen structure, the heat being transferred from the first platen structure and the second platen structure to the laminate.

### Example 15

The device according to any one of examples 1 to 14 further comprising: heating the first platen structure during a first time period with at least one of the plurality of heaters; and heating the second platen structure during a second time period with at least one of the plurality of heaters, wherein the first time period is different from the second time period.

### Example 16

The device according to any one of examples 1 to 15 further comprising: providing a plurality of heaters configured to each heat one of a plurality of zones of the first platen structure; providing a plurality of heaters configured to each heat one of a plurality of zones of the second platen structure; heating one of the plurality of zones of the first platen structure during a first time period with at least one of the plurality of heaters; and heating one of the plurality of zones of the second platen structure during a second time period with at least one of the plurality of heaters, wherein the first time period is different from the second time period.

### Example 17

A process configured to produce a composite part, comprising: providing a first platen structure; providing a second platen structure; providing a first plate structure; providing a second plate structure; providing a first press pad; providing a second press pad; arranging the first platen structure, the first plate structure, and the first press pad to form a first assembly; arranging the second platen structure, the second plate structure, and the second press pad to form a second assembly; and receiving a laminate in a cavity between the first assembly and the second assembly, the cavity including a wall structure arranged to surround the laminate, wherein the wall comprises an insulating material.

### Example 18

The process according to example 17 wherein the wall comprises a ceramic material.

### Example 19

The process according to any one of examples 17 to 18 further comprising moving the first assembly towards the second assembly to apply pressure to the laminate arranged in the cavity with an actuation mechanism, heating during a first phase the first platen structure and the second platen structure while the actuation mechanism applies a nominal pressure to the laminate arranged in the cavity; heating during a second phase, to heat the first platen structure and the second platen structure, while the actuation mechanism is configured to increase application of pressure to the laminate arranged in the cavity; and cooling during a third phase, the first platen structure and the second platen structure, while the actuation mechanism is configured to continue to apply pressure to the laminate arranged in the cavity.

### Example 20

The process according to any one of examples 17 to 19 wherein the first assembly telescopes into the second assembly.

### Example 21

The process according to any one of examples 17 to 20 wherein the first assembly and the second assembly form a sheer edge press construction.

### Example 22

The process according to any one of examples 17 to 21 wherein the wall comprises an insulating material that is configured to provide a heat Delta.

### Example 23

The process according to any one of examples 17 to 22 wherein the wall comprises an insulating material that is configured to reduce flash.

### Example 24

The process according to any one of examples 17 to 23 wherein the first press pad and the second press pad comprise at least one of the following: para-aramid fiber, meta-aramid fiber, graphite sheeting, and glass.

### Example 25

The process according to any one of examples 17 to 24 wherein the laminate comprises a plurality of laminate layers.

### Example 26

The process according to any one of examples 17 to 25 further comprising a heater configured to heat the first platen structure and the second platen structure, the heat being transferred from the first platen structure and the second platen structure to the laminate.

### Example 27

The process according to any one of examples 17 to 26 wherein the first plate structure and the second plate structure comprises metal.

### Example 28

The process according to any one of examples 17 to 27 wherein the first plate structure and the second plate structure comprises steel.

### Example 29

The process according to any one of examples 17 to 28 wherein the first plate structure and the second plate structure comprising stainless steel.

### Example 30

The process according to any one of examples 17 to 29 further comprising a plurality of heaters configured to heat the first platen structure and the second platen structure, the heat being transferred from the first platen structure and the second platen structure to the laminate.

### Example 31

The process according to any one of examples 17 to 30 wherein: the at least one of the plurality of heaters is configured to heat the first platen structure during a first time period; and the at least one of the plurality of heaters is configured to heat the second platen structure during a second time period; and wherein the first time period is different from the second time period.

### Example 32

The process according to any one of examples 17 to 31 further comprising: a plurality of heaters configured to each heat one of a plurality of zones of the first platen structure; and a plurality of heaters configured to each heat one of a plurality of zones of the second platen structure, wherein the at least one of the plurality of heaters is configured to heat one of the plurality of zones of the first platen structure during a first time period; wherein the at least one of the plurality of heaters is configured to heat one of the plurality of zones of the second platen structure during a second time period; wherein the first time period is different from the second time period.

While the disclosure has been described in terms of exemplary aspects, those skilled in the art will recognize that the disclosure can be practiced with modifications in the spirit and scope of the appended claims. These examples given above are merely illustrative and are not meant to be an exhaustive list of all possible designs, aspects, applications or modifications of the disclosure.

1. A device configured to produce a composite part, the device comprising:
a first platen structure;
a second platen structure;
a first plate structure;
a second plate structure;
a first press pad;
a second press pad,
wherein the first platen structure, the first plate structure, and the first press pad form a first assembly and
wherein the second platen structure, the second plate structure, and the second press pad form a second assembly; and
a cavity for receiving a laminate arranged between the first assembly and the second assembly, the cavity including a wall structure arranged to surround the laminate,
wherein the wall structure comprises an insulating material.

2. The device according to claim 1 wherein the wall structure comprises a ceramic material.

3. The device according to claim 1, wherein the device further comprises:
an actuation mechanism configured to move the first assembly towards the second assembly to apply pressure to the laminate arranged in the cavity; and
a heater,
wherein
the heater is configured during a first phase to heat the first platen structure and the second platen structure while the actuation mechanism applies a nominal pressure to the laminate arranged in the cavity,
the heater is further configured during a second phase to heat the first platen structure and the second platen structure while the actuation mechanism is configured to increase application of pressure to the laminate arranged in the cavity, and
the heater is configured to operate during a third phase to allow the first platen structure and the second platen structure to cool while the actuation mechanism is configured to continue to apply pressure to the laminate arranged in the cavity.

4. The device according to claim 1, wherein:
the first assembly telescopes into the second assembly; and
the first assembly and the second assembly form a sheer edge press construction.

5. The device according to claim 1 wherein the wall structure comprises an insulating material that is configured to provide a heat delta.

6. The device according to claim 1 wherein the wall structure comprises an insulating material that is configured to reduce flash.

7. The device according to claim 1 wherein the first press pad and the second press pad comprise at least one of para-aramid fiber, meta-aramid fiber, graphite sheeting, and glass.

8. The device according to claim 1 further comprising providing a plurality of heaters configured to heat the first platen structure and the second platen structure, the heat being transferred from the first platen structure and the second platen structure to the laminate.

9. The method according to claim 11, further comprising:
heating the first platen structure during a first time period with at least one of a plurality of heaters; and
heating the second platen structure during a second time period with at least one of a plurality of heaters,
wherein the first time period is different from the second time period.

10. A method of using the device to form the composite part of claim 1, the method comprising:
heating one or more of a plurality of zones of a first platen structure during a first time period with at least one of a plurality of heaters; and
heating one or more of a plurality of zones of a second platen structure during a second time period with at least one of a plurality of heaters,
wherein the first time period is different from the second time period.

11. A method for producing a composite part, comprising:
arranging a first platen structure, a first plate structure, and a first press pad to form a first assembly;
arranging a second platen structure, a second plate structure, and a second press pad to form a second assembly;
arranging the first assembly and the second assembly to form a cavity therebetween; and
disposing a laminate in the cavity between the first assembly and the second assembly, the cavity including a wall structure configured to surround the laminate,
wherein the wall structure comprises an insulating material.

12. The method according to claim 11 wherein the wall structure comprises a ceramic material.

13. The method according to claim 11 further comprising:
moving the first assembly towards the second assembly to apply pressure to the laminate arranged in the cavity with an actuation mechanism;
heating, during a first phase, the first platen structure and the second platen structure while the actuation mechanism applies a nominal pressure to the laminate disposed in the cavity;
heating, during a second phase, to heat the first platen structure and the second platen structure, while the actuation mechanism is configured to increase application of pressure to the laminate disposed in the cavity; and
cooling or allowing to cool, during a third phase, the first platen structure and the second platen structure, while the actuation mechanism is configured to continue to apply pressure to the laminate arranged in the cavity.

14-16. (canceled)

17. The method according to claim 11 wherein the first press pad and the second press pad comprise at least one of para-aramid fiber, meta-aramid fiber, graphite sheeting, and glass.

18. (canceled)

19. The device according to claim 1, further comprising
at least one of a plurality of heaters is configured to heat the first platen structure during a first time period; and
at least one of a plurality of heaters is configured to heat the second platen structure during a second time period; and
wherein the first time period is different from the second time period.

20. The device according to claim 1, further comprising:
a plurality of heaters configured to each heat at least one of a plurality of zones of the first platen structure; and
a plurality of heaters configured to each heat at least one of a plurality of zones of the second platen structure,
wherein
the at least one of the plurality of heaters is configured to heat at least one of the plurality of zones of the first platen structure during a first time period,
the at least one of the plurality of heaters is configured to heat at least one of the plurality of zones of the second platen structure during a second time period, and
the first time period is different from the second time period.

21. A method of using the device of claim 1, the method comprising:
arranging a laminate in the cavity;
heating the laminate to a higher temperature;
while at the higher temperature, increasing pressure to the laminate to a higher pressure; and
while at the higher pressure, cooling the laminate.

22. The method according to claim 21, further comprising maintaining the laminate at the higher pressure until the laminate is cooled to a removal temperature, then decreasing the pressure on the laminate, and removing the laminate from the cavity

23. The method according to claim 22, wherein the laminate is removed from the cavity at the removal temperature.

24. The method according to claim 22, wherein the higher pressure is a maximum pressure, and wherein the higher temperature is a maximum temperature.
